(19) United States
(12) Patent Application Publication
(10) Pub. No.: US 2009/0193720 A1
(43) Pub. Date: Aug. 6, 2009

(54) Window assembly with upper sash rail stiffening member supporting tilt latch bolts

(75) Inventors: Michael A. Duncan, Mohnton, PA (US); Philip G. Morton, Germantown, OH (US); Christopher R. Ballard, Miamisburg, OH (US)

Correspondence Address: Alan F. Meckstroth;JACOX, MECKSTROTH & JENKINS, Suite 2, 2310 Far Hills Building, Dayton, OH, 45419-1575, US

(73) Assignees: Deceuninck North America, LLC; Viwinco, Inc.

(21) Appl. No.: 12/012,995

(22) Filed: Feb. 6, 2008

(51) Int. Cl. E06B 1/26

(52) U.S. Cl. 49/504

(57) ABSTRACT

A single or double hung window assembly has a rectangular main frame supporting at least one rectangular sash frame for vertical sliding movement, and each frame has members formed from extrusions including rigid plastics material. A horizontal upper sash rail or member is reinforced by an elongated and continuous metal stiffening channel having a width substantially greater than its height and defining a longitudinally extending and upwardly facing undercut cavity. End portions of the stiffening channel support retractable sliding tilt latch bolts each having a snap-fit connection to a corresponding actuator slidably mounted on the upper sash rail. A sash lock member is also mounted on the upper sash rail and is secured to the stiffening channel. A pre-assembly of the stiffening channel and latch bolts is inserted through an opening in a vertical sash frame member, and stiffening channels are also inserted into other sash frame members.

### BACKGROUND OF THE INVENTION

This invention relates to a double hung or single hung window assembly fabricated from extrusions of rigid plastics material such as rigid polyvinyl chloride, and of the general type disclosed in U.S. Pat. No. 6,675,537 and No. 6,826,871 assigned to the assignee of the present invention, and the disclosures of which are herein incorporated by reference. In such window assemblies, and especially large window assemblies, the horizontal sash rail members are typically not sufficiently stiff to withstand the structural pressures resulting from high winds which occur, for example during a hurricane or tornado, and which tend to pull the fabricated sash frame and glass assembly out of the fabricated main frame assembly. Thus the sash frame members are commonly reinforced with stiffening bars or members which are configured to fit with minimum clearance inside the hollow sash rail members, for example, as disclosed in above-mentioned U.S. Pat. No. 6,826,871.

The vertically sliding window units of a single hung or double hung window assembly are also commonly designed so that the movable or operable sash frames can be disengaged from the outer main frame and then tilted inwardly of the building to provide access for cleaning the exterior surface of the glass window panel from the interior of the building. The tilt latches, such as disclosed in the above-mentioned patents and in other U.S. patents, are designed for releasably securing the upper sash rail of the operable sash frame in its normal operating position and may be released or disengaged for tilting the sash frame into the building. Sometimes, the tilt latch bolts may be integrated or connected to the sash frame security lock mechanism which are partially recessed within the upper rail of the movable sash frame, for example, as disclosed in U.S. Pat. No. 7,070,211.

### SUMMARY OF THE INVENTION

The present invention is directed to an improved single hung or double hung window assembly and which includes a rectangular main frame having a pair of vertical jamb members rigidly connected by a horizontal sill member and a horizontal head member. The main frame supports at least one vertically movable or operable rectangular sash frame having vertical sash frame members rigidly connected by horizontal sash frame members or rails and supporting a glass panel unit. All of the frame members are formed from extrusions comprising a rigid plastic material, and the upper sash frame member or rail of each vertically movable or operable window unit incorporates an elongated stiffening bar or member which not only reinforces the sash frame rail but also functions as a housing for supporting the tilt latch bolts which releasably engage the vertical jamb members of the outer main frame.

The stiffening bar or member has a continuous profile or cross-section along its entire length and extends from the left jamb member of the outer frame to the right jamb member of the outer frame. The bottom horizontal sash frame member or rail may also be configured to receive the stiffening bar or member so that different stiffening bars are not required, for example, as disclosed in above-mentioned U.S. Pat. No. 6,826,871. The stiffening bar or member which carries the tilt latch bolts may also be pre-assembled and conveniently assembled into the upper sash frame rail through an opening within an upper end portion of a vertical sash frame member after the corners of the sash frame members are secured or welded together. The stiffening bar or member also forms a structurally rigid support for attaching a security sash lock member on the top surface of the upper sash frame rail of the operable window unit.

### BRIEF DESCRIPTION OF THE DRAWINGS

FIG. 1 is an elevational view of a double hung window assembly constructed in accordance with the invention;

FIG. 2 is a larger vertical section of the window assembly taken generally on the line 2-2 of FIG. 1 and with upper and lower portions broken away;

FIG. 3 is a fragmentary section taken generally on the line 3-3 of FIG. 1;

FIG. 4 is a fragmentary section similar to FIG. 3 with the top wall of the upper sash frame rail broken away;

FIG. 5 is an enlarged fragmentary section taken generally on the line 5-5 of FIG. 1;

FIG. 6 is an enlarged fragmentary section taken generally on the line 6-6 of FIG. 1; and

FIG. 7 is a reduced fragmentary section taken generally on the line 7-7 of FIG. 6.

### DESCRIPTION OF THE PREFERRED EMBODIMENT

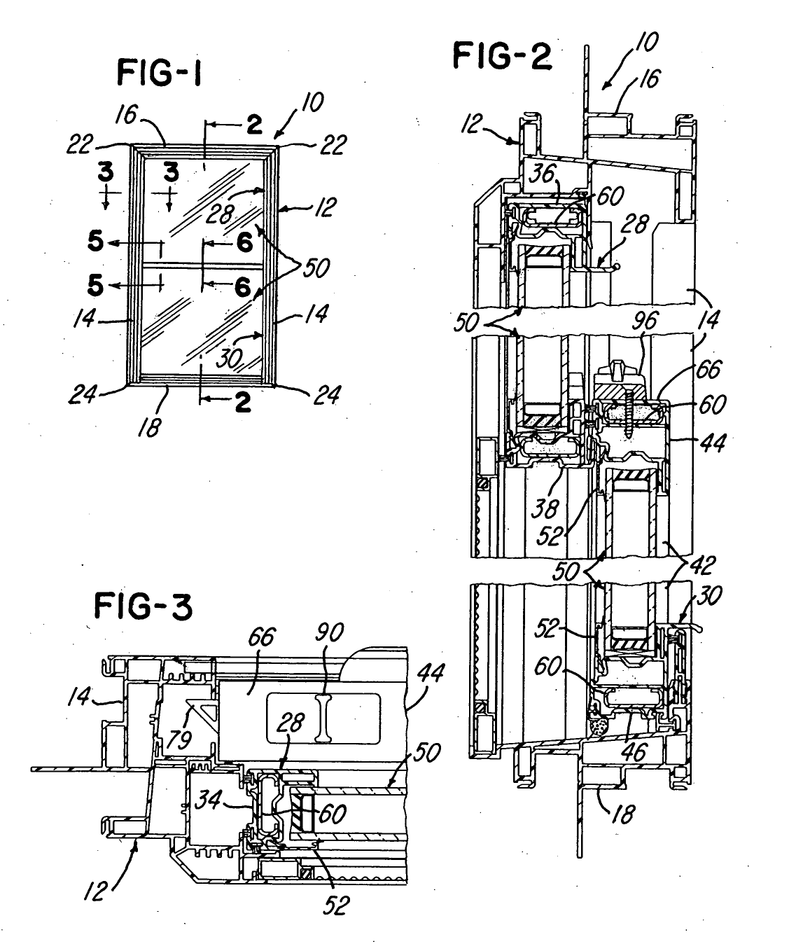

FIG. 1 illustrates a double hung window assembly 10 which includes a rectangular outer main frame 12 formed by a pair of vertical frame or jamb members 14 connected by a horizontal head member 16 and a horizontal sill member 18. The main frame members 14, 16 and 18 are formed from extrusions of a rigid material including a rigid plastics material such as a rigid polyvinylchloride (PVC) with the extruded sections having 45 degree mitered ends rigidly connected or welded to form mitered upper corner joints 22 and lower corner joints 24. The main frame 12 is constructed generally the same as disclosed in above-mentioned U.S. Pat. No. 6,675,537, the disclosure of which is herein incorporated by reference. As also disclosed in this patent, the main frame 12 supports an upper sash frame 28 and a lower sash frame 30 for vertical sliding movement between closed positions (FIGS. 1 & 2) and open positions (not shown). The upper sash frame 28 is formed by a pair of vertical sash members 34 (FIG. 3) rigidly connected by a horizontal upper sash frame member or rail 36 (FIG. 2) and a horizontal lower sash frame member or rail 38. Similarly, the lower sash frame 30 is formed by a pair of vertical sash frame members 42 (FIG. 2) rigidly connected by an upper sash frame member or rail 44 and a horizontal lower sash frame member or rail 46. All of the sash frame members are also formed from extrusions including a rigid plastics material such as PVC, and the vertical and horizontal sash frame members are rigidly connected by welded mitered corners. Each of the sash frames 28 and 30 encloses insulated glazing panels or a glass unit 50 which is removably retained by extruded plastic removable glazing beads 52. The disclosures of above-mentioned U.S. Pat. No. 6,675,537 and No. 6,826,871 are referred to for further details of construction of the window assembly 10.

In accordance with the present invention, the upper horizontal sash member or rail 44 of the lower sash frame 30 is extruded with an upper rectangular cavity or chamber 58 (FIGS. 5 & 6) which receives a rigid reinforcing and stiffening member 60 in close fitting relation. The stiffening member 60 is preferably in the form of a roll-formed or extruded metal or aluminum C-shaped channel 60 having longitudinally extending and opposing top return flanges 62 defining a longitudinally extending undercut cavity 64. The stiffening channel 60 has a horizontal width substantially greater than its vertical thickness and extends closely between a top wall 66 and a parallel intermediate or inner wall 68 and the opposite side walls of the upper sash rail 44. The channel 60 extends the full length of the upper sash rail 44 and has a uniform cross-sectional configuration or profile along its entire length in order to provide the strength necessary to resist bending or bowing of the sash rail.

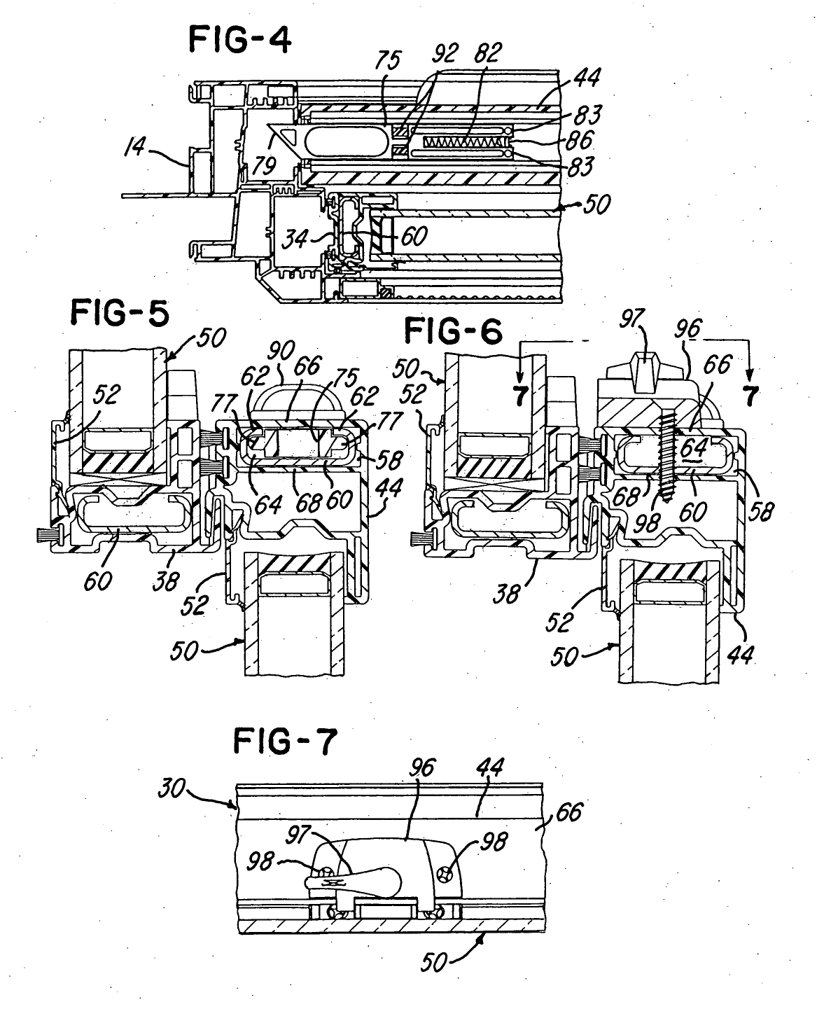

As shown in FIG. 4, the opposite end portions of the stiffening member or channel 60 support corresponding tilt latch bolts 75 for horizontal sliding movement. Each bolt 75 is preferably molded of a rigid plastics material and has longitudinally extending ribs 77 projecting along opposite sides under the return flanges 62 of the stiffening channel 60. Each tilt latch bolt 75 also has a triangular shape outer end portion 79 which normally engages and locks to the adjacent jamb member 14 of the main window frame 12. Each latch bolt 75 is biased outwardly by a compression spring 82 (FIG. 4) which extends between parallel spaced legs 83 of the latch bolt and engages a tab 86 formed or lanced upwardly from the bottom wall of the stiffening channel 60. Each of the latch bolts 75 is manually shifted between its normal extended latch position (FIG. 4) and a retracted position compressing the spring 82 by a molded plastic thumb actuator 90 (FIG. 3) having a pair of downwardly projecting hook shaped fingers or tabs 92 (FIG. 4) which extend through corresponding slots within the top wall 66 and into recesses within the latch bolt and snap-fit onto the latch bolt. The tilt latch bolt actuators 90 slide on the top wall 66 of the upper sash member or rail 44.

As shown in FIGS. 6 & 7, the upper wall 66 of the sash rail 44 also supports a sash lock member 96 of a conventional cam operated security lock having a rotatable locking lever 97. The sash lock member 96 is rigidly secured to the stiffening channel 60 by a pair of self-tapping screws 98 threaded into the top wall 66, the bottom wall of the channel 60 and also through the intermediate wall 68 of the upper sash rail 44. As also shown in FIGS. 2-6, each of the other vertical and horizontal sash frame members 34, 36 and 38 of the upper sash frame 28 and the vertical and horizontal sash frame members 42 and 46 of the lower sash frame 30 are extruded with cavities or chambers similar in cross-section to the chamber 58 for also receiving and confining sections of the stiffening member or channel 60 for further reinforcing the sash frames. The stiffening channel 60 in the upper horizontal sash member 36 also supports tilt latch bolts 75 to provide for tilting the upper sash frame 28 inwardly for cleaning after the lower sash frame 30 is tilted inwardly for cleaning.

From the drawings and the above description, it is apparent that a window assembly constructed in accordance with the invention provides desirable features and advantages. For example, the uniform cross-sectional configuration of the stiffening member or channel 60 along its entire length not only provides substantial strength and rigidity to the sash members to resist high wind forces such as occurs during a hurricane or tornado, but the stiffening channels 60 in the upper sash members 44 and 36 also provide a rigid and high strength support housing for the corresponding sliding tilt latch bolts 75. As another advantage and feature, the two tilt latch bolts 75 and the corresponding compression springs 82 may be pre-assembled into the stiffening channel 60. This pre-assembly may then be inserted into the chamber 58 through a rectangular opening in a vertical sash frame member 34 after the mitered corners have been welded together. The hook-shaped tabs 92 of the latch bolt actuators 90 are then snap-fitted onto the corresponding latch bolts through the corresponding slots within the top wall 66 of the sash rail. As a further advantage, the configuration or profile of the stiffening member 60 also permits additional linear sections of the stiffening member 60 to be inserted in the other sash frame members 34, 36, 38, 42 and 46 for reinforcing and stiffening the members, as shown in FIGS. 2-6.

While the form of window assembly herein described constitutes a preferred embodiment of the invention, it is to be understood that the invention is not limited to this precise form of window assembly, and that changes may be made therein without departing from the scope and spirit of the invention as defined in the appended claims.

What is claimed is:

1. A window assembly comprising
a main frame including vertical main frame members rigidly connected by horizontal main frame members with said vertical main frame members defining opposing vertical guides,
at least one window unit including a sash frame having vertical sash frame members rigidly connected by horizontal sash frame members and enclosing a glazing unit, with said sash frame supported by said vertical guides for vertical movement between open and closed positions,
all of said main frame members and said sash frame members comprising a rigid plastics material with at least an upper said horizontal sash frame member having spaced walls defining an internal cavity extending horizontally between said vertical main frame members,
an elongated rigid sash stiffening member disposed within said cavity and having longitudinally extending walls extending continuously adjacent said spaced walls of said upper sash frame member,
said stiffening member having a horizontal width substantially greater than its vertical height to resist bowing of said upper sash frame member in response to differential air pressure on said sash frame and said glazing unit, and further having opposite end portions adjacent said vertical main frame members,
a set of tilt latch bolts supported for sliding movement within said opposite end portions of said stiffening member and biased laterally outwardly to engage the corresponding said vertical main frame members, and
a pair of tilt latch bolt actuators adjacent opposite end portions of said upper sash frame member with each said actuator connected to the corresponding said tilt latch bolt and providing for sliding said tilt latch bolt to a retracted position within said stiffening member.

2. A window assembly as defined in claim 1 wherein said stiffening member comprises an upwardly facing C-shaped stiffening channel having longitudinally extending and opposing top return flanges projecting inwardly from opposite side walls of said stiffening channel and defining an open top undercut cavity, and each of said tilt latch bolts includes opposite side portions projecting under said return flanges.

3. A window assembly as defined in claim 2 wherein each of said tilt latch bolts has a vertical thickness substantially equal to a vertical height of said undercut cavity.

4. A window assembly as defined in claim 2 wherein said opposite side portions of each of said tilt latch bolts comprise longitudinally extending and outwardly projecting ribs projecting under said return flanges.

5. A window assembly as defined in claim 1 wherein each of said tilt latch bolt actuators includes a downwardly projecting portion extending through an opening within a top wall of said upper horizontal sash frame member and forming a snap-fit connection with the corresponding said tilt latch bolt.

6. A window assembly as defined in claim 1 wherein said horizontal width of said stiffening member is about three times said vertical height.

7. A window assembly as defined in claim 1 and including a sash lock member mounted on a top wall of said upper horizontal sash frame member and secured by fasteners threaded into a bottom wall of said sash stiffening member.

8. A window assembly as defined in claim 1 wherein other said sash frame members have spaced walls defining longitudinally extending cavities receiving elongated sections of said stiffening member in close-fit relation.

9. A window assembly as defined in claim 1 and including a pre-assembly of said tilt latch bolts within said stiffening member, and a vertical said sash frame member has a top opening aligned with said cavity within said upper sash frame member for receiving said pre-assembly within said sash frame.

10. A window assembly comprising
a main frame including vertical main frame members rigidly connected by horizontal main frame members with said vertical main frame members defining opposing vertical guides,
at least one window unit including a sash frame having vertical sash frame members rigidly connected by horizontal sash frame members and enclosing a glazing unit, with said sash frame supported by said vertical guides for vertical movement between open and closed positions,
all of said main frame members and said sash frame members comprising a rigid plastics material with at least an upper said horizontal sash frame member having spaced walls defining an internal cavity extending horizontally between said vertical main frame members,
an elongated rigid C-shaped sash stiffening channel disposed within said cavity and having longitudinally extending opposite side walls extending continuously adjacent spaced side walls of said upper sash frame member to restrict bowing of said upper sash frame member in response to differential air pressure on said sash frame and said glazing unit,
said stiffening channel having longitudinally extending and opposing top return flanges projecting inwardly from said side walls of said channel and further having opposite end portions adjacent said vertical main frame members,
a set of tilt latch bolts supported for sliding movement within said opposite end portions of said stiffening channel with each said latch bolt having opposite side portions projecting under said return flanges and biased laterally outwardly to engage the corresponding said vertical main frame members, and
a pair of tilt latch bolt actuators adjacent opposite end portions of said upper sash frame member with each said actuator connected to the corresponding said tilt latch bolt and providing for sliding said tilt latch bolt to a retracted position within said stiffening channel.

11. A window assembly as defined in claim 10 wherein each of said tilt latch bolts has a vertical thickness substantially equal to a vertical height of said undercut cavity.

12. A window assembly as defined in claim 10 wherein said opposite side portions of each of said tilt latch bolts comprise longitudinally extending and outwardly projecting ribs projecting under said return flanges.

13. A window assembly as defined in claim 10 wherein each of said tilt latch bolt actuators includes a downwardly projecting portion extending through an opening within a top wall of said upper horizontal sash frame member and forming a snap-fit connection with the corresponding said tilt latch bolt.

14. A window assembly as defined in claim 10 wherein a horizontal width of said stiffening channel is substantially greater than its vertical height.

15. A window assembly as defined in claim 10 and including a sash lock member mounted on a top wall of said upper horizontal sash frame member and secured by fasteners threaded into a bottom wall of said sash stiffening channel.

16. A window assembly as defined in claim 10 wherein other said sash frame members have spaced walls defining longitudinally extending cavities receiving elongated sections of said stiffening channel in close-fit relation.

17. A window assembly as defined in claim 10 and including a pre-assembly of said tilt latch bolts within said stiffening channel, and a vertical said sash frame member has a top opening aligned with said cavity within said upper sash frame member for receiving said pre-assembly within said sash frame.

18. A window assembly comprising
a main frame including vertical main frame members rigidly connected by horizontal main frame members with said vertical main frame members defining opposing vertical guides,
at least one window unit including a sash frame having vertical sash frame members rigidly connected by horizontal sash frame members and enclosing a glazing unit, with said sash frame supported by said vertical guides for vertical movement between open and closed positions,
all of said main frame members and said sash frame members comprising a rigid plastics material with at least an upper said horizontal sash frame member having spaced walls defining an internal cavity extending horizontally between said vertical main frame members,
an elongated rigid C-shaped sash stiffening channel disposed within said cavity and having longitudinally extending opposite side walls extending continuously adjacent spaced side walls of said upper sash frame member to resist bowing of said upper sash frame member in response to differential air pressure on said sash frame and said glazing unit,
said cavity and said channel each having a horizontal width substantially greater than its vertical height,
said stiffening channel having longitudinally extending and opposing top return flanges projecting inwardly from said side walls of said channel and further having opposite end portions extending to said vertical main frame members,
a set of tilt latch bolts supported for sliding movement within said opposite end portions of said stiffening channel with each said latch bolt having opposite side portions projecting under said return flanges and biased laterally outwardly to engage the corresponding said vertical main frame members, and
a pair of tilt latch bolt actuators mounted on opposite end portions of said upper sash frame member with each said actuator having a depending tab connected to the corresponding said tilt latch bolt and providing for sliding said tilt latch bolt to a retracted position within said stiffening channel.

19. A window assembly as defined in claim 18 wherein said opposite side portions of each of said tilt latch bolts comprise longitudinally extending and outwardly projecting ribs projecting under said return flanges.

20. A window assembly as defined in claim 18 and including a pre-assembly of said tilt latch bolts within said stiffening channel, and a vertical said sash frame member has a top opening aligned with said cavity within said upper sash frame member for receiving said pre-assembly after said sash frame members are rigidly connected.

21. A window assembly comprising
a main frame including vertical main frame members rigidly connected by horizontal main frame members with said vertical main frame members defining opposing vertical guides,
at least one window unit including a sash frame having vertical sash frame members rigidly connected by horizontal sash frame members and enclosing a glazing unit, with said sash frame supported by said vertical guides for vertical movement between open and closed positions,
all of said main frame members and said sash frame members comprising a rigid plastics material with at least one said horizontal sash frame member having spaced walls defining an internal cavity having a horizontal width substantially greater than its vertical height and extending horizontally between said vertical main frame members,
an elongated C-shaped sash stiffening channel disposed within said cavity and having longitudinal walls extending continuously adjacent said spaced walls of said one sash frame member,
said stiffening channel having longitudinally extending opposing return flanges and a horizontal width substantially greater than its vertical height to resist bowing of said horizontal sash frame member in response to differential air pressure on said sash frame and said glazing unit, and
said stiffening channel having opposite end portions adjacent said vertical main frame members.

22. A window assembly as defined in claim 21 wherein other said sash frame members have spaced walls defining longitudinally extending cavities receiving elongated sections of said stiffening channel in close-fit relation.
